(19) United States
(12) Patent Application Publication
(10) Pub. No.: US 2022/0299979 A1
(43) Pub. Date: Sep. 22, 2022

(54) PREVENTIVE MAINTENANCE SUPPORT SYSTEM AND PREVENTIVE MAINTENANCE SUPPORT METHOD

(71) Applicant: Hitachi, Ltd., Tokyo (JP)

(72) Inventor: Akihiro OYAMA, Tokyo (JP)

(73) Assignee: HITACHI, LTD., Tokyo (JP)

(21) Appl. No.: 17/463,277

(22) Filed: Aug. 31, 2021

(30) Foreign Application Priority Data
Mar. 22, 2021 (JP) 2021-047394

(51) Int. Cl. G05B 19/418; G05B 23/02

(52) U.S. Cl. CPC G05B 19/4184; G05B 19/41865; G05B 23/0283

(57) ABSTRACT

A preventive maintenance support system 1 includes a CPU 10 and a memory unit 11. The CPU 10 causes a display unit 14 to display a timing chart for displaying a timing at which inventory of components included in a product increases or decreases, a timing at which the components are stocked at a manufacturing site of the product, and a necessary inventory timing at which the components are replaced for preventive maintenance of the product.

### CROSS-REFERENCE TO PRIOR APPLICATION

This application relates to and claim the benefit of priority from Japanese Patent Application No. 2021-47394 filed on Mar. 22, 2021 the entire disclosure of which is incorporated herein by reference.

### BACKGROUND

The present invention relates to a preventive maintenance support system and a preventive maintenance support method.

In the predictive diagnosis, faults are prevented from occurring in advance by performing appropriate diagnosis in accordance with changes in state of apparatuses or components by maintenance service know-how or data mining (operation information, a past fault history, or the like output daily from apparatuses or products), and thus it can be expected that it will be possible to avoid losses due to operation stop or an improvement in an operative rate through predictive detection.

Considering “preventive maintenance” through the predictive diagnosis, a replacement component when predictive sign is detected has to be taken into account similarly to occurrence of faults. When replacement components are secured, it is necessary to take consideration so that there is no influence on manufacturing while being conscious of a lead time such as a deadline (it is necessary to secure the replacement components apart from manufacturing).

When replacement arises, it is necessary to determine an optimum replacement time (Field Change (FC)) while considering a situation in which a component of each apparatus is mounted during operation, an operation period, or the like. When components are secured, maintenance inventories or manufacturing inventories are also used for the meantime. However, it causes “pre-use of a manufacturing demand,” so, it is necessary to proceed with working and securing of replacement components appropriately in “preventive maintenance” while observing a demand for manufacturing components and manipulating the number of purchase orders.

As a system supporting the above-described preventive maintenance, for example, an information processing apparatus disclosed in Japanese Patent Application Laid-open No. 2018-173793 is known. The information processing apparatus in Japanese Patent Application Laid-open No. 2018-173793 “specifies a maintenance working target product based on fault information of the product and predicts occurrence of faults of components of the maintenance working target product, and then determines priorities for the maintenance working in accordance with faults of which occurrence is predicted in components in which occurrence of the faults is predicted and adjusts a schedule of maintenance working of the specified target product in accordance with the priorities and dates on which components in which occurrence of faults is predicted will be able to be obtained.”

In the above-described information processing apparatus disclosed in Japanese Patent Application Laid-open No. 2018-173793, however, a schedule of maintenance working of components of which occurrence of a fault is predicted is merely adjusted and coordination of a manufacturing schedule of a product manufactured using the components has not been taken into consideration.

The present invention has been devised in view of the foregoing problems and an objective of the present invention is to provide a preventive maintenance support system and a preventive maintenance support method capable of sufficiently achieving coordination with a manufacturing schedule.

### SUMMARY

To solve the above-described problems, according to an aspect of the present invention, a preventive maintenance support system includes a processor and a storage unit. The processor causes a display apparatus to display a timing chart for displaying timings at which inventories of components included in a product will increase or decrease, timings at which the components will be received at a manufacturing site of the product, and a necessary inventory timing at which the components are will be able to be replaced for preventive maintenance of the product.

According to the present invention, it is possible to realize a preventive maintenance support system and a preventive maintenance support method capable of sufficiently achieving coordination with a manufacturing schedule.

### BRIEF DESCRIPTION OF THE DRAWINGS

FIG. 1 is a diagram illustrating a preventive maintenance support system and peripheral systems according to an embodiment;

FIG. 2 is a block diagram illustrating an overall configuration of the preventive maintenance support system according to the embodiment;

FIG. 3 is a diagram illustrating a customer operation status table of the preventive maintenance support system according to the embodiment;

FIG. 4 is a diagram illustrating a maintenance component inventory table of the preventive maintenance support system according to the embodiment;

FIG. 5 is a diagram illustrating an arrival status table of the preventive maintenance support system according to the embodiment;

FIG. 6 is a diagram illustrating an ordering status table of the preventive maintenance support system according to the embodiment;

FIG. 7 is a diagram illustrating a lead time and price information table of the preventive maintenance support system according to the embodiment;

FIG. 8 is a diagram illustrating a component list of the preventive maintenance support system according to the embodiment;

FIG. 9 is a diagram illustrating a component inventory table of the preventive maintenance support system according to the embodiment;

FIG. 10 is a diagram illustrating a traceability information table of the preventive maintenance support system according to the embodiment;

FIG. 11 is a diagram illustrating a finished Assy product and inventory table of the preventive maintenance support system according to the embodiment;

FIG. 12 is a diagram illustrating a delivery schedule table of the preventive maintenance support system according to the embodiment;

FIG. 13 is a diagram illustrating an assembly lead time table of the preventive maintenance support system according to the embodiment;

FIG. 14 is a diagram illustrating a mounting schedule table of the preventive maintenance support system according to the embodiment;

FIG. 15 is a diagram illustrating an assembly input schedule table of the preventive maintenance support system according to the embodiment;

FIG. 16 is a diagram illustrating a customer priority table of the preventive maintenance support system according to the embodiment;

FIG. 17 is a diagram illustrating an example of a timing chart of the preventive maintenance support system according to the embodiment;

FIG. 18 is a diagram illustrating a display example of predictive sign detection and predictive sign assumption in the timing chart of the preventive maintenance support system according to the embodiment;

FIG. 19 is a diagram illustrating a display example of grouping in accordance with customer priority in the timing chart of the preventive maintenance support system according to the embodiment;

FIG. 20 is a diagram illustrating a display example of a preventive maintenance block in the timing chart of the preventive maintenance support system according to the embodiment;

FIG. 21 is a diagram illustrating a legend of each block in the timing chart of the preventive maintenance support system according to the embodiment;

FIG. 22 is a diagram illustrating an example of a change in the timing chart when a time window is moved in the preventive maintenance support system according to the embodiment;

FIG. 23 is a diagram illustrating another example of a change in the timing chart when the time window is moved in the preventive maintenance support system according to the embodiment;

FIG. 24 is a flowchart illustrating an example of an operating information checking operation in the preventive maintenance support system according to the embodiment;

FIG. 25 is a flowchart illustrating another example of the operating information checking operation in the preventive maintenance support system according to the embodiment;

FIG. 26 is a flowchart illustrating an example of a manufacturing information checking operation in the preventive maintenance support system according to the embodiment;

FIG. 27 is a flowchart illustrating an example of a procurement information checking operation in the preventive maintenance support system according to the embodiment;

FIG. 28 is a flowchart illustrating an example of an operation of displaying in the timing chart in the preventive maintenance support system according to the embodiment;

FIG. 29 is a flowchart illustrating an example of an operation of manipulating a time window in the preventive maintenance support system according to the embodiment;

FIG. 30 is a flowchart illustrating another example of the operation of manipulating a time window in the preventive maintenance support system according to the embodiment;

FIG. 31 is a flowchart illustrating an example of an alert determination and replacement determination operation in the preventive maintenance support system according to the embodiment; and

FIG. 32 is a flowchart illustrating an example of an additional component necessity date determination operation in the preventive maintenance support system according to the embodiment.

### DETAILED DESCRIPTION OF THE EMBODIMENT

Hereinafter, embodiments will be described with reference to the drawings. The embodiments to be described below do not limit the invention of the claims, and not all the elements described in the embodiments or all combinations of the elements are requisites for solutions of the present invention.

In the drawings used to describe an embodiment, similar reference numerals are given to portions with similar functions and repeated description thereof will be omitted.

In the following description, an expression of “xxx data” is used as an example of information in some cases, but any data structure of information may be used. That is, to express that information does not depend on a data structure, “xxx data” can be referred to as an “x×x table.” Further, “xxx data” can also be referred to as simply “xxx.” In the following description, a configuration of each piece of information is exemplary and information may be stored by being separated from or combined with each other.

In the following description, processing will be described using a “program” serving as a subject in some cases. However, the program is executed by a processor (for example, a CPU (Central Processing Unit)) so that given processing is performed using storage resources (for example, a memory) and/or a communication interface device (for example, a port) appropriately. Therefore, a subject of the processing may be a program. Processing described using the program as a subject may be processing performed by a processor or a computer that includes a processor.

To solve the foregoing problems, for example, a preventive maintenance support system according to the embodiment unitarily ascertains information (aggregates information) of an apparatus, such as operation information or manufacturing information (mounting information) of other customers, various kinds of inventory information (maintenance and manufacturing), and purchase information (arrival and ordering) in addition to QA knowledge or operative information (health information) used for diagnosis using predictive signs, and determines an optimum execution time of replacement working (FC (Field Change)) performed after predictive sign detection.

In a general maintenance management system, there is a problem that it is difficult to create a replacement plan including securing of components because manufacturing information (mounted component information) of an apparatus (a product) and operation information of maintenance are not sufficiently coordinated and it may be difficult to ascertain all operation statuses (numbers, locations, and times) of components. In addition, on a purchase side, it may be difficult to make predictions for demands regarding preventive maintenance, such as the demand for components based on operation information or predictive sign detection, and on a business site there are concerns regarding the amount or remaining shelving when ordering the number of components expected to be added for the manufacturing (for preventive maintenance). In addition, systems or management (maintenance, manufacturing, and purchase) are each independent, and thus there is a probability of mutual coordination being not sufficiently achieved.

In the preventive maintenance support system according to the embodiment, purchasing can be handled based on a replacement schedule and an inventory (maintenance and manufacturing) status and replacement work can be planned based on the influence on manufacturing. Further, the influence on other customers can be estimated and such influences can be minimized.

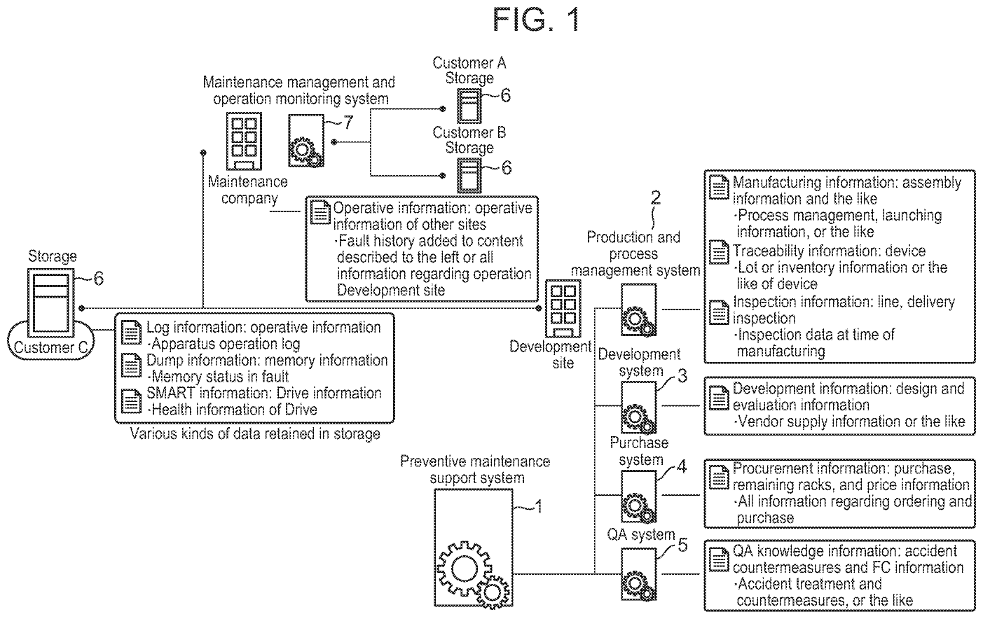

FIG. 1 is a diagram illustrating a preventive maintenance support system and peripheral systems according to an embodiment.

A preventive maintenance support system 1 according to the embodiment coordinates with a production and process control system 2, a development system 3, a purchase system 4, and a QA system 5 located at a development site to acquire various kinds of information regarding these systems 2 to 5 and perform a preventive maintenance support operation.

A preventive maintenance target of the preventive maintenance support system 1 according to the embodiment is a storage system (in the drawing, abbreviated to a “storage”) 6 provided in a location of a customer in the example illustrated in FIG. 1. In the storage system 6, maintenance management and operation monitoring are performed daily or periodically by a maintenance management and operation monitoring system 7 located in a maintenance company. The preventive maintenance support system 1 according to the embodiment also acquires various kinds of information regarding the storage system 6 and the maintenance management and operation monitoring system 7 and performs a preventive maintenance support operation.

The preventive maintenance support system 1 according to the embodiment is manipulated mainly by an operator located in the maintenance company, and can also be manipulated by an operator located at the development site if necessary.

All the various kinds of information illustrated in FIG. 1 are not requisites of the preventive maintenance support system 1 according to the embodiment.

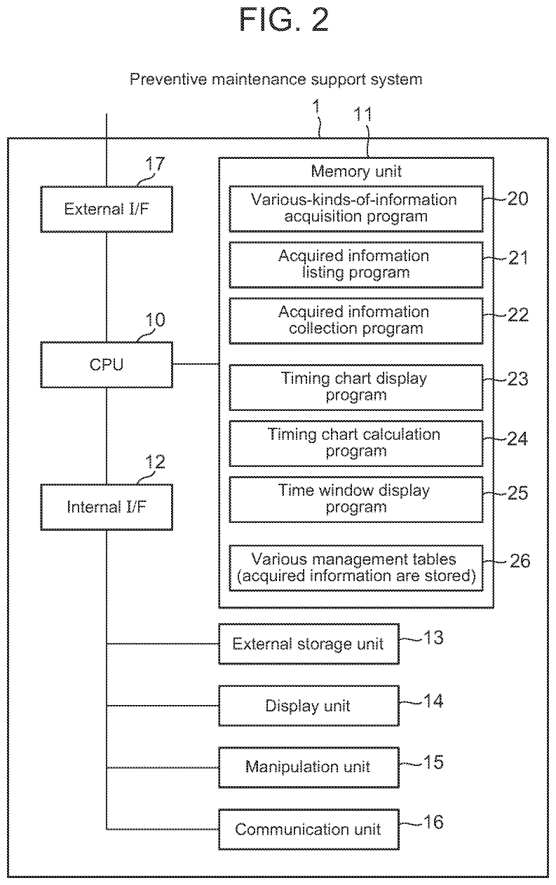

FIG. 2 is a block diagram illustrating an overall configuration of the preventive maintenance support system 1 according to the embodiment.

The preventive maintenance support system 1 illustrated in FIG. 2 is an apparatus capable of performing various kinds of information processing and is, for example, an information processing apparatus such as a computer. The preventive maintenance support system 1 includes a processor 10 typified by a CPU and a memory unit 11 and further includes an external storage unit 13, a display unit 14, a manipulation unit 15, and a communication unit 16 via an internal I/F (interface) 12. Further, the preventive maintenance support system 1 performs communication with the various systems 2 to 7 illustrated in FIG. 1 via the external I/F 17.

The processor 10 is, for example, a CPU (Central Processing Unit), a GPU (Graphics Processing Unit), an FPGA (Field Programmable Gate Array), or the like. The memory unit 11 includes, for example, a magnetic storage medium such as an HDD (Hard Disk Drive) or a semiconductor storage medium such as a RAM (Random Access Memory), a ROM (Read Only Memory), or an SSD (Solid State Drive). A combination of an optical disc such as a DVD (Digital Versatile Disk) and of an optical disc drive is also used as a memory. In addition, a known storage medium such as a magnetic tape medium is also used as a memory.

The memory unit 11 stores a program such as a firmware. When an operation of the preventive maintenance support system 1 starts (for example, power is supplied), the program such as firmware is read from the memory and is executed to control the entire preventive maintenance support system 1. The memory unit 11 stores data or the like necessary for each processing of the preventive maintenance support system 1 in addition to the program.

The preventive maintenance support system 1 according to the embodiment may be configured by a so-called cloud configured so that a plurality of information processing apparatuses can communicate with each other via a communication network.

The memory unit 11 of the preventive maintenance support system 1 according to the embodiment stores a various-kinds-of-information acquisition program 20, an acquired information listing program 21, an acquired information collection program 22, a timing chart display program 23, a timing chart calculation program 24, and a time window display program 25 as programs and realizes functional units corresponding to the programs by executing the programs. Functions performed by functional units corresponding to the programs will be described later in detail. A summary of the functions will be described below.

The various-kinds-of-information acquisition program 20 acquires information necessary for an operation of the preventive maintenance support system 1 from the above-described various systems 2 to 7. The acquired information listing program 21 lists information acquired by the various-kinds-of-information acquisition program 20. The acquired information collection program 22 collects the information listed by the acquired information listing program 21. The timing chart display program 23 causes the display unit 14 to display a timing chart. The timing chart calculation program 24 performs various calculations necessary to display timing charts based on various management tables 26 stored in the preventive maintenance support system 1. The time window display program 25 causes the display unit 14 to display a time window by superimposing the time window on a timing chart.

The memory unit 11 of the preventive maintenance support system 1 according to the embodiment stores the various management tables 26. The details of the various management tables 26 will be described below in detail.

The external storage unit 13 stores various kinds of information like the memory unit 11. The external storage unit 13 is a storage medium that has a storage capacity larger than the memory unit 11 and includes, for example, a magnetic storage medium such as an HDD or a semiconductor storage medium such as an SSD (Solid State Drive). The display unit 14 is, for example, a liquid crystal display and displays various kinds of information based on instructions from the processor 10 (which is a functional unit realized by executing various kinds of programs stored in the memory unit 11). The various kinds of information displayed by the display unit 14 include a timing chart and a time window. The manipulation unit 15 includes, for example, an input device such as a keyboard or a mouse, accepts an operation input from an operator of the preventive maintenance support system 1 and outputs an input signal based on the operation input. The communication unit 16 performs communication with the various systems 2 to 7 via the external I/F 17.

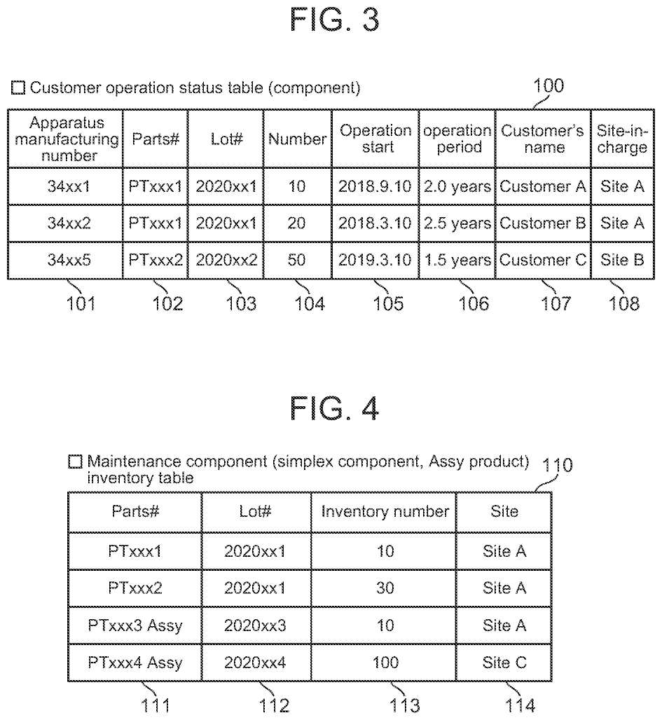

Next, details of the various management tables 26 stored in the memory unit 11 of the preventive maintenance support system 1 will be described with reference to FIGS. 3 to 16.

FIG. 3 is a diagram illustrating a customer operation status table of the preventive maintenance support system 1 according to the embodiment.

A customer operation status table 100 illustrated in FIG. 3 is a table indicating an operation status of a component (part) in the storage system 6 installed for a customer and has, as entries, an apparatus manufacturing number 101, a part number (#) 102, a lot number 103, a number 104, an operation start 105, an operation period 106, a customer's name 107, and a site-in-charge 108.

The apparatus manufacturing number 101 is an apparatus manufacturing number of the storage system 6 installed for the customer. The part number 102 is a component (part) number included in the storage system 6. The lot number 103 is a lot number of a part included in the storage system 6. The number 104 is the number of parts included in the storage system 6. The operation start 105 is a start date of operation of a part included in the storage system 6. The operation period 106 is an operation period of a part included in the storage system 6. The customer's name 107 is a name of a customer that retains the storage system 6. The site-in-charge 108 is a name of a site at which maintenance of the storage system 6 is in charge.

FIG. 4 is a diagram illustrating a maintenance component inventory table of the preventive maintenance support system 1 according to the embodiment.

A maintenance component inventory table 110 illustrated in FIG. 4 is a table indicating an inventory status of components at a site of a maintenance company and has, as entries, a part number (#) 111, a lot number 112, the inventory number 113, and a site 114.

The part number 111 is a component (part) number in stock. The lot number 112 is a lot number of a part, an inventory number 113 is the number of parts in an inventory, and the site 114 is a name of a site in which the parts are in stock.

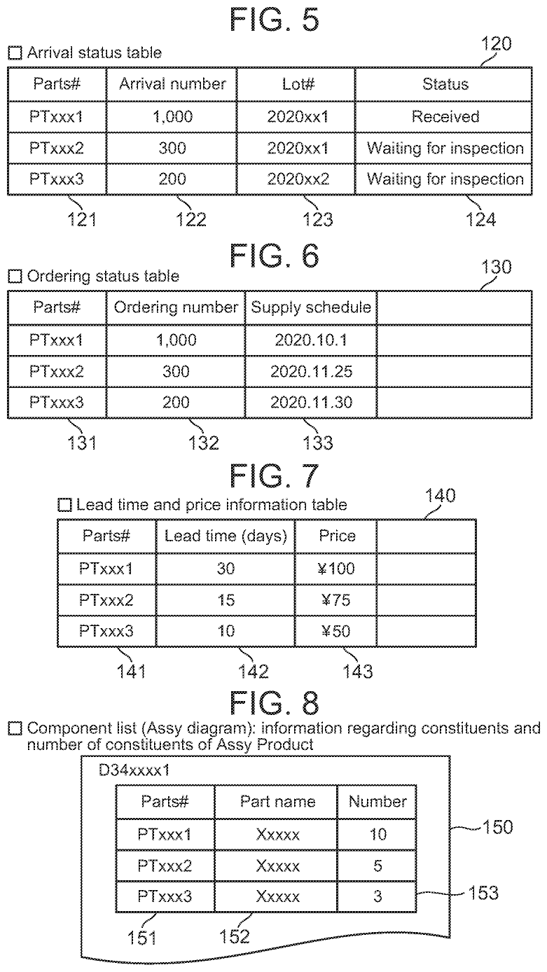

FIG. 5 is a diagram illustrating an arrival status table of the preventive maintenance support system 1 according to the embodiment.

An arrival status table 120 illustrated in FIG. 5 is a table indicating an arrival status of a part at a site of a maintenance company and has, as entries, a part number 121, a arrival number 122, a lot number 123, and a status 124.

The part number 121 is a part number included in the storage system 6, the arrival number 122 is the number of arrived parts, the lot number 123 is a lot number of a part, and the status 124 is a status of the part.

FIG. 6 is a diagram illustrating an ordering status table of the preventive maintenance support system 1 according to the embodiment.

An ordering status table 130 illustrated in FIG. 6 is a table indicating an ordering status of a part at the site of the maintenance company and has, as entries, a part number 131, an ordering number 132, and a supply schedule 133.

The part number 131 is a part number which is ordered, the ordering number 132 is the number of ordered parts which have been ordered, and the supply schedule 133 is a schedule date on which a part will be supplied.

FIG. 7 is a diagram illustrating a lead time and price information table of the preventive maintenance support system 1 according to the embodiment.

A lead time price information table 140 illustrated in FIG. 7 is a table indicating a lead time and price information of a part ordered from the maintenance company and has, as entries, a part number 141, a lead time 142, and a price 143.

The part number 141 is a part number which is ordered, the lead time 142 is a number of days from ordering to arrival of a part (a lead time), and the price 143 is a price of the part.

FIG. 8 is a diagram illustrating a component list of the preventive maintenance support system 1 according to the embodiment.

A component list 150 illustrated in FIG. 8 is a list of components of an assembly product, that is, an intermediate product manufactured by externally purchasing the components and assembling components in an own company (a development site) and is generated for each intermediate product. For the component list 150, a number 151 of an intermediate product is attached as an index. The component list 150 has, as entries, a part number 152, a part name 153, and a number 154.

The part number 152 is a part number included in the intermediate product, the part name 153 is a name of a part, and the number 154 is the number of parts necessary to finish the intermediate product.

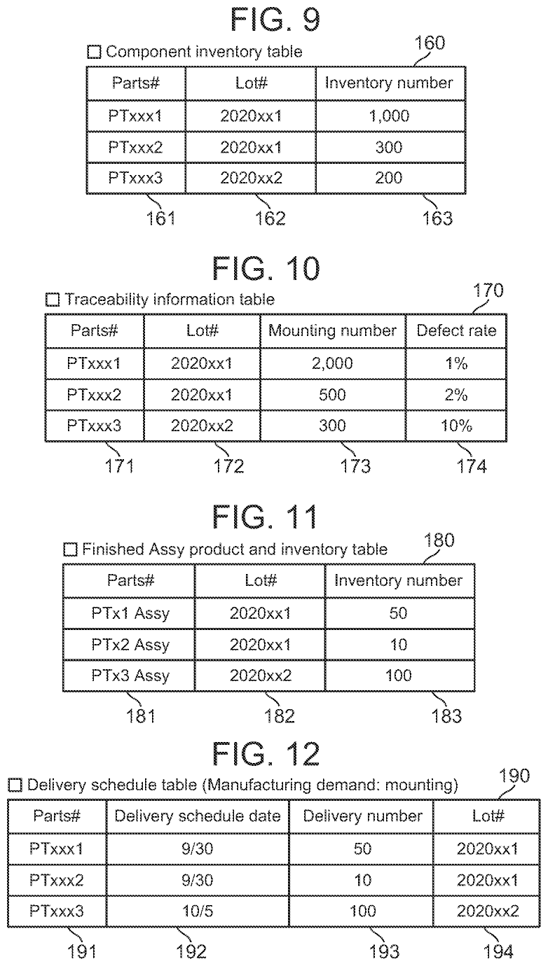

FIG. 9 is a diagram illustrating a component inventory table of the preventive maintenance support system 1 according to the embodiment.

A component inventory table 160 illustrated in FIG. 9 is a table indicating an inventory status of components at the development site and has, as entries, a part number 161, a lot number 162, and an inventory number 163.

The part number 161 is a part number, the lot number 162 is a lot number of a part, and the inventory number 163 is the number of parts in an inventory at the development site.

FIG. 10 is a diagram illustrating a traceability information table of the preventive maintenance support system 1 according to the embodiment.

A traceability information table 170 illustrated in FIG. 10 is a table related to traceability of parts included in a product (mounted in the product) and has, as entries, a part number 171, a lot number 172, a mounting number 173, and a defect rate 174.

The part number 171 is a part number, the lot number is a lot number of a part, the mounting number 173 is a total number (mounting number) of parts mounted in the product, and the defect rate 174 is a defect rate for an individual part.

FIG. 11 is a diagram illustrating a finished Assy product and inventory table of the preventive maintenance support system 1 according to the embodiment.

A finished Assy product and inventory table 180 illustrated in FIG. 11 is a table indicating a finished inventory status of an Assy product (intermediate product) at the development site and has, as entries, a part number 181, a lot number 182, and an inventory number 183.

The part number 181 is an intermediate product number, the lot number is a lot number of the intermediate product, and the inventory number 183 is the number of intermediate products in an inventory at the development site.

FIG. 12 is a diagram illustrating a delivery schedule table of the preventive maintenance support system 1 according to the embodiment.

A delivery schedule table 190 illustrated in FIG. 12 is a table indicating a delivery schedule of parts (that is, delivery of parts as a manufacturing demand) necessary to manufacture the product at the development site and has, as entries, a part number 191, a delivery schedule date 192, a delivery number 193, and a lot number 194.

The part number 191 is a part number necessary to manufacture the product, the delivery schedule date 192 is a delivery schedule date of parts from an external manufacturer, the delivery number 193 is a delivery number of parts from the external manufacturer, and the lot number 194 is a lot number of the part.

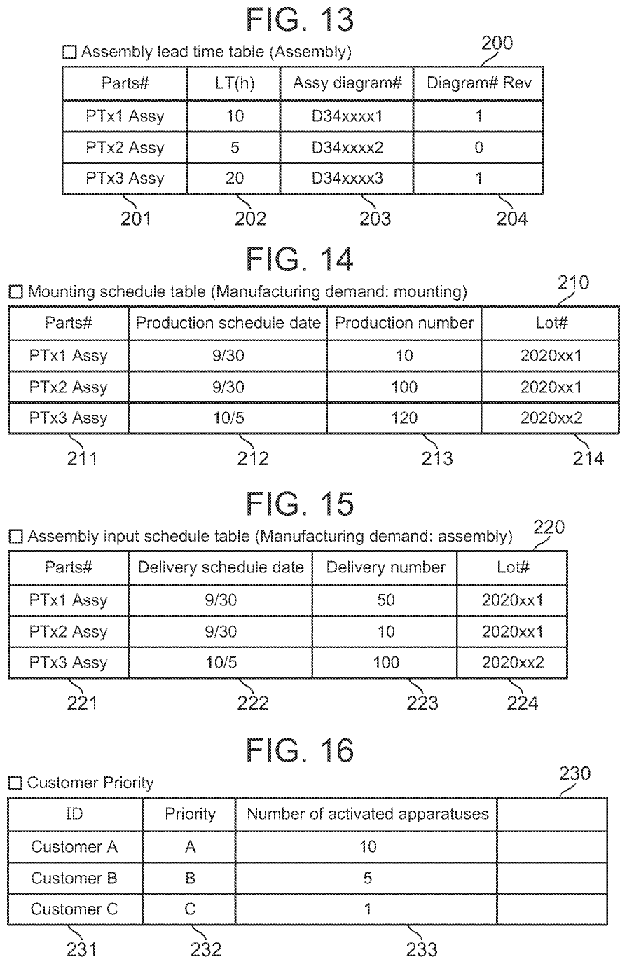

FIG. 13 is a diagram illustrating an assembly lead time table of the preventive maintenance support system 1 according to the embodiment.

An assembly lead time table 200 illustrated in FIG. 13 is a table indicating a lead time related to assembly of the intermediate product at the development site and has, as entries, a part number 201, a lead time 202, an Assy diagram 203, and a diagram number 204.

The part number 201 is an intermediate product number, the lead time 202 is a lead time taken until the components are manufactured as the intermediate product, the Assy diagram 203 is a diagram number necessary to assemble the intermediate product, and the diagram number 204 is a revision number of the diagram.

FIG. 14 is a diagram illustrating a mounting schedule table of the preventive maintenance support system 1 according to the embodiment.

A mounting schedule table 210 illustrated in FIG. 14 is a table indicating an assembly schedule (a mounting schedule) of the intermediate product at the development site and has, as entries, a part number 211, a production schedule date 212, a production number 213, and a lot number 214.

The part number 211 is an intermediate product number, the production schedule date 212 is a production schedule date of the intermediate product, the production number 213 is a production (schedule) number of intermediate products on the production schedule date 212, and the lot number is a lot number of the intermediate product.

FIG. 15 is a diagram illustrating an assembly input schedule table of the preventive maintenance support system 1 according to the embodiment.

An assembly input schedule table 220 illustrated in FIG. 15 is a table indicating an input schedule (a manufacturing demand for the intermediate product) of the intermediate product necessary to assemble the product at the development site and has, as entries, a part number 221, a delivery schedule date 222, a delivery number 223, and a lot number 224.

The part number 221 is an intermediate product number, the delivery schedule date 222 is a delivery schedule date of the intermediate product, the delivery number 223 is a delivery (schedule) number of the intermediate product on the delivery schedule date 222, and the lot number is a lot number of the intermediate product.

FIG. 16 is a diagram illustrating a customer priority table of the preventive maintenance support system 1 according to the embodiment.

A customer priority table 230 illustrated in FIG. 16 is a table indicating priority for customers for whom the storage system 6 is installed and has, as entries, an ID 231, a priority 232, and the number of operated apparatuses 233.

The ID 231 is an ID of a customer, the priority 232 is priority of preventive maintenance for the customer identified with the ID 231, and the number of operated apparatuses 233 is the number of operated storage systems 6 installed for the customers specified with the IDs 231.

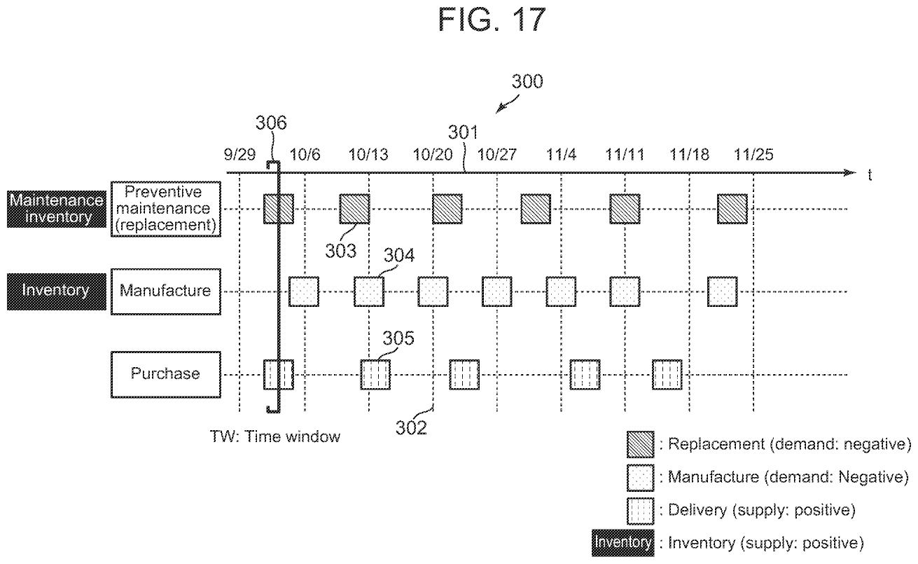

Next, an overview of an operation of the preventive maintenance support system 1 according to the embodiment will be described with reference to FIGS. 17 to 23 using timing charts and time windows displayed on the display unit 14 of the preventive maintenance support system 1 according to the embodiment.

FIG. 17 is a diagram illustrating an example of a timing chart of the preventive maintenance support system 1 according to the embodiment.

A timing chart 300 illustrated in FIG. 17 is displayed on the display unit 14 of the preventive maintenance support system 1. An example illustrated in FIG. 17 is a timing chart when components are purchased externally and the components are assembled at the development site to manufacture a product. A timing chart when an intermediate product is assembled at the development site and the product is further manufactured will be described later.

In the timing chart 300, a time axis 301 is displayed in a direction oriented in the longitudinal direction of the drawing (a horizontal direction). The time axis 301 is displayed in units of weeks and a current date corresponds to a week of 9/29 to 10/6 in the example of the drawing. A dashed line 302 indicating a partition of the week is displayed in the transverse direction of the drawing (the vertical direction).

In the timing chart 300, blocks 303, 304, and 305 indicating a preventive maintenance timing, a timing at which a product is manufactured using the components, and a timing at which the components are purchased are displayed in units of weeks on the time axis 301.

The details of legends of the blocks 303 to 305 will be described later. When described in brief, the block 303 indicating a preventive maintenance timing represents that components for preventive maintenance are replaced at this timing and component inventory decreases due to replacement of the components. Accordingly, the block 303 indicates a demand for the components. The block 304 indicating the timing at which the product is manufactured represents that the product is manufactured using components at the development site and the component inventory decreases due to manufacturing of the product. Accordingly, the block 304 also indicates a demand for the components. The block 305 indicating the timing at which the components are purchased represents that the components arrive at the development site and the component inventory increases due to the arrival of the components. Accordingly, the block 305 indicates a supply of the components.

In the timing chart 300, a time window 306 for determining a timing at which components are replaced for preventive maintenance is displayed. As will be described in detail below, the time window 306 can be moved on the time axis 301 in the units of weeks based on a manipulation input by an operator of the preventive maintenance support system 1.

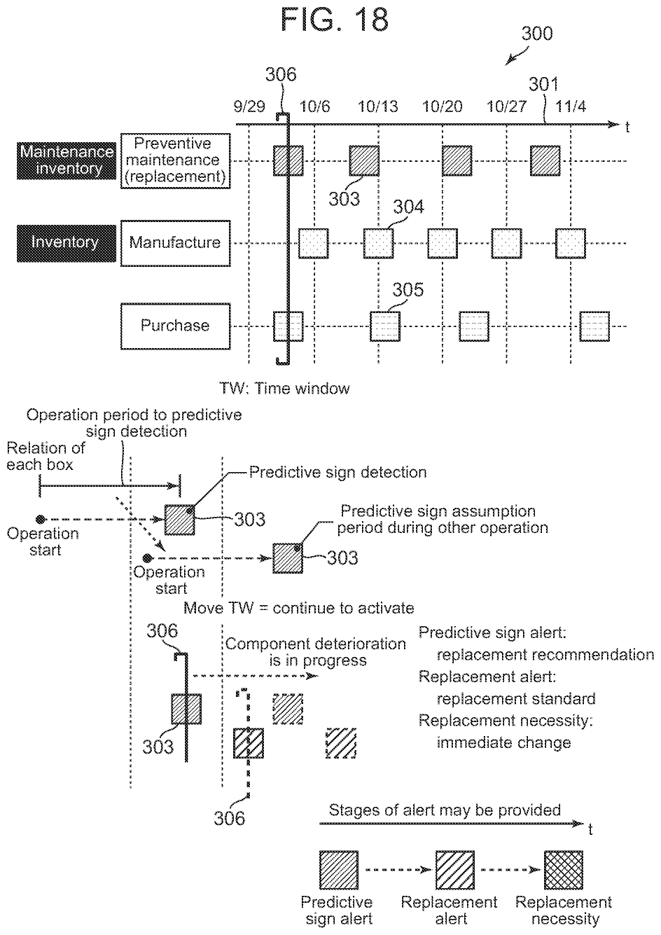

FIG. 18 is a diagram illustrating a display example of predictive sign detection and predictive sign assumption in the timing chart 300 of the preventive maintenance support system 1 according to the embodiment.

How display of the timing chart 300, in particular, the block 303 indicating the timing of the preventive maintenance, is changed at the time of movement of the time window 306 and change in the timing at which the components are replaced for the preventive maintenance will be described with reference to FIG. 18.

In the preventive maintenance support system 1 according to the embodiment, it is detected that components on which the preventive maintenance is performed will be replaced for preventive maintenance when a predetermined operation period from start of operation to predictive sign detection has passed. At a timing of the predictive sign detection, the preventive maintenance support system 1 according to the embodiment is scheduled to perform the preventive maintenance of a plurality of kinds of components and a plurality of products and actually performs the preventive maintenance, and therefore each component is counted from an operation start period. When the time window 306 is moved in a direction in which the time axis 301 passes (that is, the right in the drawing), the timing at which the components are replaced is instructed to be late. As a result, it is determined that component deterioration is in progress.

A display pattern of the block 303 is changed in accordance with a period from the operation start of the components. For example, as illustrated in the lower part of FIG. 18, there are three kinds of patterns, a pattern indicating an predictive sign alert (recommendation for replacing the components), a pattern indicating a replacement alert (a standard timing of the component replacement), and a pattern indicating replacement necessity (immediate replacement).

To display the replacement alert and the replacement necessity, the preventive maintenance support system 1 has two thresholds. That is, when a period from a date indicating a position of the time window 306 to a date corresponding to the block 303 exceeds a second threshold, the display of the block 303 is changed to the replacement necessity. When the period from the date indicating the position of the time window 306 to the date corresponding to the block 303 exceeds a first threshold, the display of the block 303 is changed to the replacement alert. When the period from the date indicating the position of the time window 306 to the date corresponding to the block 303 is equal to or smaller than a first threshold, the display of the block 303 remains in the predictive sign alert. Configuration values of the first and second thresholds can be configured to any values when the configuration value of the second threshold is smaller than the configuration value of the first threshold.

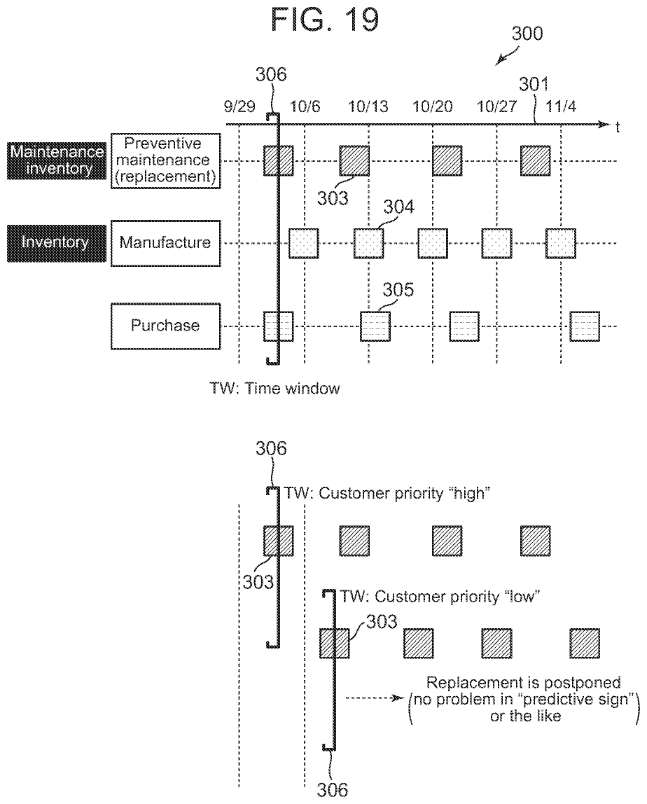

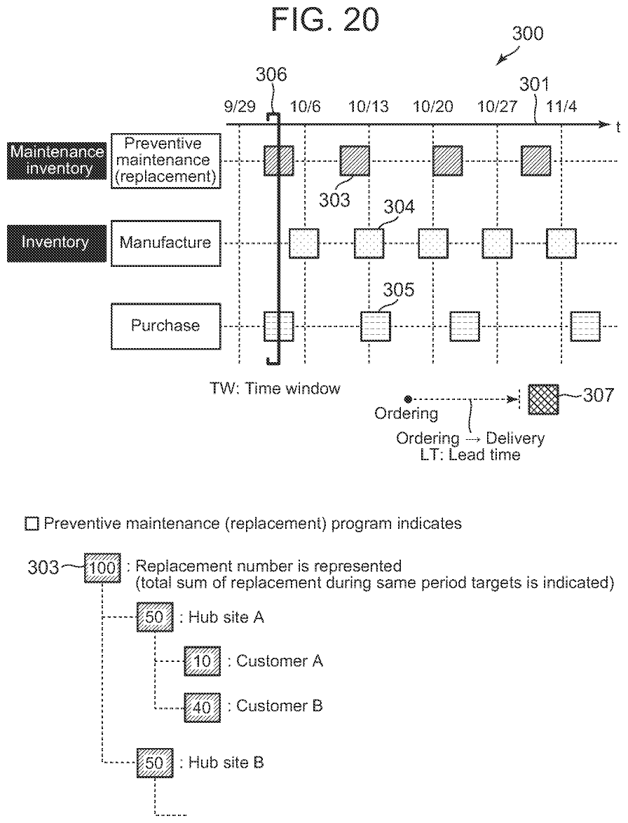

FIG. 19 is a diagram illustrating a display example of a group in accordance with customer priority in the timing chart 300 of the preventive maintenance support system 1 according to the embodiment.

The block 303 indicating the preventive maintenance timing can be grouped based on customer priority configured for each customer, as indicated in the customer priority table 230 of FIG. 16. In the example illustrated in FIG. 19, the block 303 indicating the preventive maintenance timing for the components mounted in the product in which the customer priority is “high” (customer priority 232 is A or B as an example in the customer priority table 230 of FIG. 16) and the block 303 indicating the preventive maintenance timing for the components mounted in the product in which the customer priority is “low” (that is, the customer priority 232 is lower than the customer priority of “high”) are displayed in two rows. For each block 303, the different time window 306 is displayed and configured.

For a customer for whom the customer priority is configured to be high, the timing at which the components are replaced can be configured to be preferred. For a customer for whom the customer priority is configured to be low, the timing at which the components are replaced can be configured to be late. In the example illustrated in FIG. 19, the blocks 303 are all displayed with the predictive sign alert. This stage is a stage in which the replacement of the components is recommended. Therefore, there is no problem although the timing at which the components are replaced is configured to be late.

FIG. 20 is a diagram illustrating a display example of a preventive maintenance block in the timing chart 300 of the preventive maintenance support system 1 according to the embodiment.

Although the timing at which the components are replaced for the preventive maintenance is determined by the time window 306, a predetermined lead time (LT) is necessary until the components are actually supplied (added to the block 305 indicating a purchase timing). Accordingly, a timing at which the components are actually replaced is later than the supply of the components. In the preventive maintenance support system 1 according to the embodiment, when an ordering period is instructed, a block 307 indicating a component delivery timing considering the lead time is displayed. Here, it is not necessary for the preventive maintenance support system 1 to perform an actual ordering operation in cooperation with the purchase system 4.

In the preventive maintenance support system 1 according to the embodiment, the block 303 indicating the preventive maintenance timing displayed in the timing chart 300 is displayed in more details, as illustrated in the lower part of FIG. 20, when the operator clicks on the block 303 with the manipulation unit 15. That is, the bock 303 is displayed in a tree and a total sum of the components to be replaced at a time point is superimposed and displayed in the block 303 which is uppermost stream. Hub sites and total sums of the components for customers belonging to the hub sites are superimposed and displayed downstream.

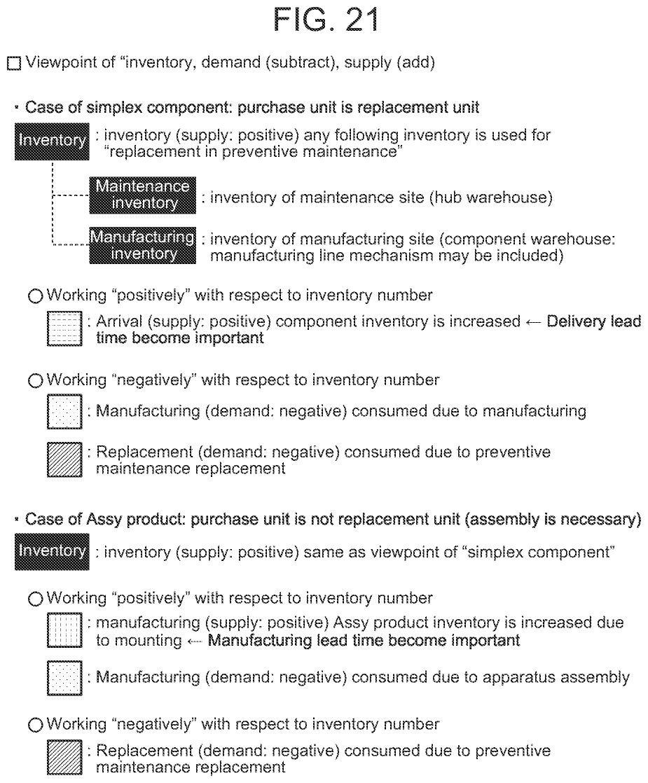

FIG. 21 is a diagram illustrating a legend of each block in the timing chart of the preventive maintenance support system according to the embodiment.

As described above, the components handled in the preventive maintenance support system 1 according to the embodiment include components used to manufacture a product by assembling the components (referred to as simplex components in FIG. 21) as they are and components assembled to manufacture an intermediate product (referred to as an Assy product in FIG. 21) so that the intermediate products (and other components as necessary) are assembled to manufacture a product. For the simplex components, a replacement unit in the preventive maintenance is the same as a component purchase unit. For the Assy product, a replacement unit in the preventive maintenance is not the same as a component purchase unit (the intermediate product is replaced in the preventive maintenance).

The inventory includes a maintenance inventory of a maintenance site of a maintenance company and manufacturing inventory of a development site (a manufacturing site). The preventive maintenance support system 1 according to the embodiment monitors both the maintenance inventory and the manufacturing inventory. When the components are replaced for the preventive maintenance, the maintenance inventory and the manufacturing inventory can be both used.

For a simplex component, arrival of the simplex component works positively with respect to the inventory number. On the other hand, manufacturing of the product and component replacement for the preventive maintenance work negatively with respect to the inventory number. For the Assy product, manufacturing of the Assy product and manufacturing of the product work positively with respect to the inventory number. On the other hand, the component replacement for the preventive maintenance works negatively with respect to the inventory number.

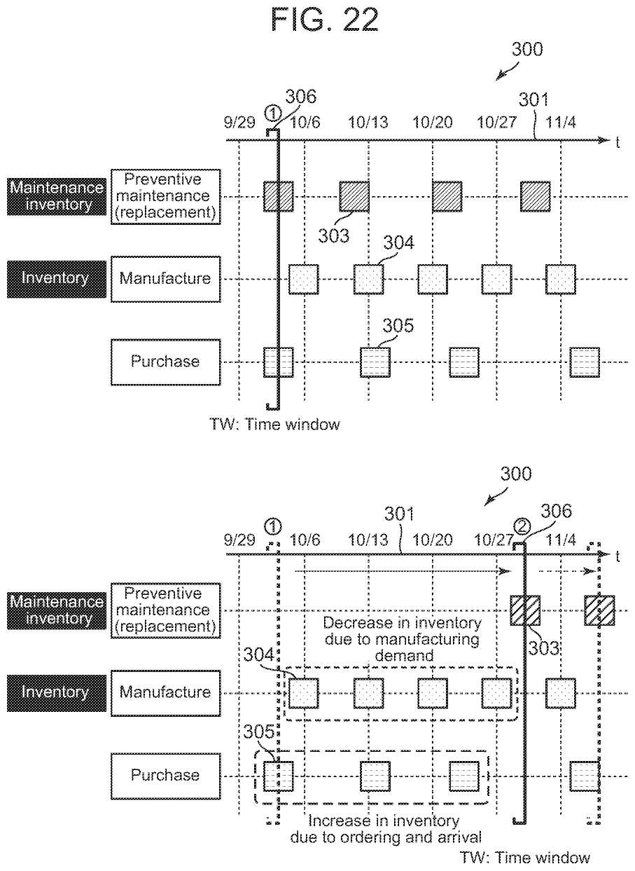

FIG. 22 is a diagram illustrating an example of a change in the timing chart 300 when the time window 306 is moved in the preventive maintenance support system 1 according to the embodiment.

The timing chart 300 illustrated in FIG. 22 is the timing chart 300 when preventive maintenance of the simplex components which are components is performed. It is assumed that the operator of the preventive maintenance support system 1 moves the time window 306 from the position of the time window 306 illustrated in the upper part of the drawing in a direction in which the time axis 301 advances (the right of the drawing) using the manipulation unit 15, as illustrated in the lower part of the drawing, to configure the replacement timing of the components based on the preventive maintenance late.

A display position of the block 303 representing the preventive maintenance timing in the timing chart 300 is moved to the right of the drawing (that is, the direction in which the time axis 301 advances) by moving the block from a position of the time window 306 (indicated by circled number 1 in the drawing) in the upper part of the drawing to a position of the time window 306 (indicated by circled number 2 in the drawing) in the lower part of the drawing. Accordingly, a display pattern of the block 303 is also changed from an predictive sign alert to a replacement alert.

By moving the position of the time window 306 in the direction in which the time axis 301 advances, the component inventory decreases due to the manufacturing of the product (product demand). Conversely, the component inventory increases due to ordering and arrival of the components. The operator can examine and determine the timing at which the components are replaced for the preventive maintenance while viewing a timing at which the display pattern of the block 303 or the component inventory increases/decreases.

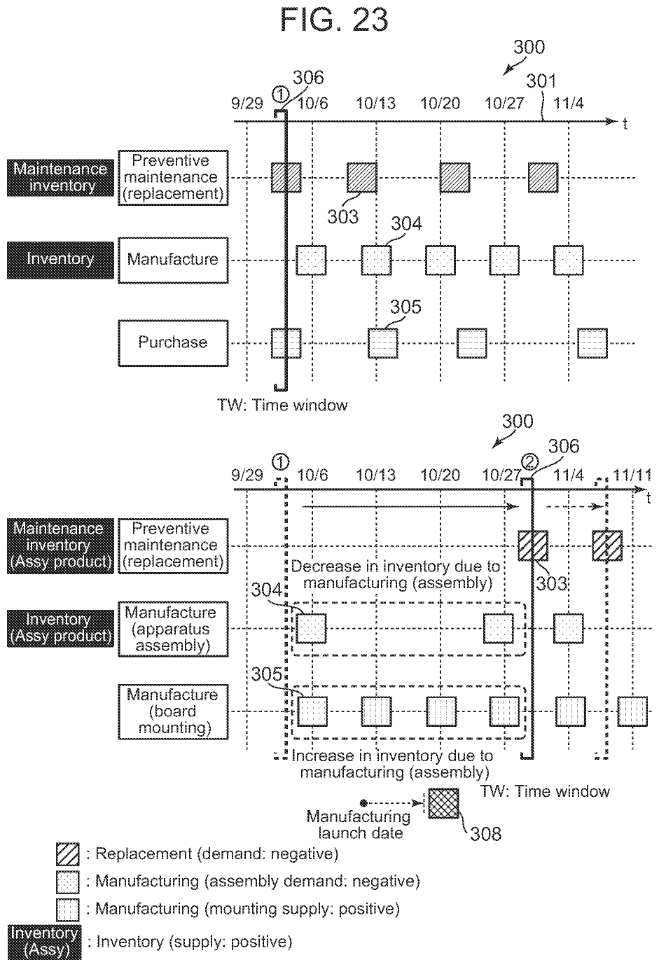

FIG. 23 is a diagram illustrating another example of the change in the timing chart 300 when the time window 306 is moved in the preventive maintenance support system 1 according to the embodiment.

The timing chart 300 illustrated in FIG. 23 is the timing chart 300 when the preventive maintenance of the Assy product which is a component is performed. Like the case of FIG. 22, it is assumed that the operator of the preventive maintenance support system 1 moves the time window 306 from the position of the time window 306 illustrated in the upper part of the drawing in a direction in which the time axis 301 advances (the right of the drawing) using the manipulation unit 15, as illustrated in the lower part of the drawing, to configure the replacement timing of the components based on the preventive maintenance late.

A display position of the block 303 representing the preventive maintenance timing in the timing chart 300 is moved to the right of the drawing (that is, the direction in which the time axis 301 advances) by moving the block from a position of the time window 306 (indicated by circled number 1 in the drawing) in the upper part of the drawing to a position of the time window 306 (indicated by circled number 2 in the drawing) in the lower part of the drawing. Accordingly, a display pattern of the block 303 is also changed from an predictive sign alert to a replacement alert.

By moving the position of the time window 306 in the direction in which the time axis 301 advances, the Assy product inventory decreases due to the manufacturing of the product (product assembly). Conversely, the Assy product inventory increases due to the assembly (board mounting) of the Assy product. The operator can examine and determine the timing at which the components are replaced for the preventive maintenance while viewing a timing at which the display pattern of the block 303 or the component inventory increases/decreases.

In the preventive maintenance support system 1 according to the embodiment, as illustrated in FIG. 20, it is possible to display a block 308 indicating manufacturing finish of the product (a finished product) considering a lead time from a manufacturing launch date of the Assy product.

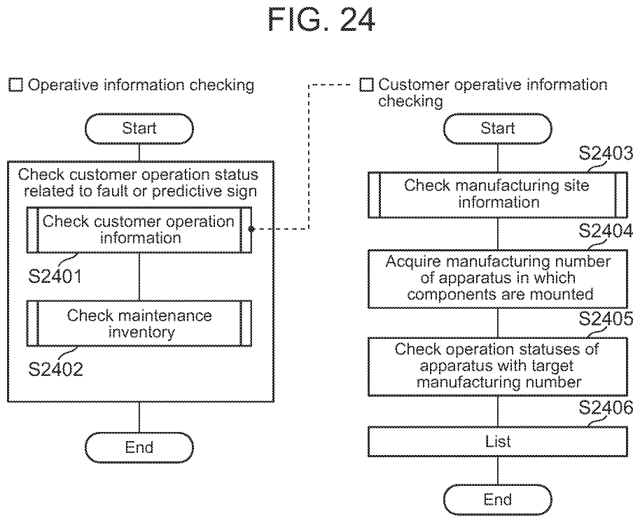

Next, operations of the preventive maintenance support system 1 according to the embodiment will be described with reference to the flowcharts of FIGS. 24 to 32.

FIG. 24 is a flowchart illustrating an example of an operative information checking operation in the preventive maintenance support system 1 according to the embodiment.

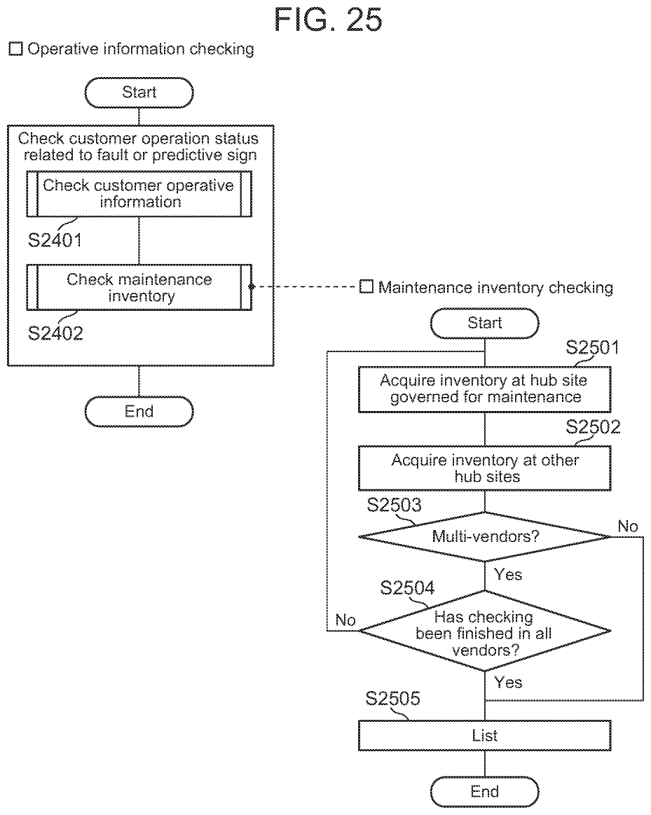

The flowcharts illustrated in FIGS. 24 and 25 are flowcharts for describing an operation in which the preventive maintenance support system 1 according to the embodiment checks operative information of the storage system 6 installed for a customer.

First, the preventive maintenance support system 1 performs a customer operative information checking operation (S2401). Subsequently, the preventive maintenance support system 1 performs a maintenance inventory checking operation (S2402).

In the customer operative information checking operation, the preventive maintenance support system 1 first performs a manufacturing site information checking operation (S2403). The manufacturing site information checking operation is an operation in which the preventive maintenance support system 1 acquires information regarding preventive maintenance target components of this system 1 from manufacturing sites. Subsequently, the preventive maintenance support system 1 acquires a manufacturing number of the apparatus in which the components acquired in S2403 are mounted (S2404). The preventive maintenance support system 1 checks operation statuses in the customer of the apparatus acquired in S2404 (S2405). Then, the preventive maintenance support system 1 lists the operation statuses of the apparatus acquired in S2404 (S2406).

FIG. 25 is a flowchart illustrating another example of the operative information checking operation in the preventive maintenance support system according to the embodiment.

In the maintenance inventory checking operation, the preventive maintenance support system 1 first acquires maintenance inventory of the components at the hub site governed by the maintenance company (S2501). Subsequently, the preventive maintenance support system 1 acquires the maintenance inventory of the components at hub sites except for the hub site governed by the maintenance company (S2502).

Subsequently, the preventive maintenance support system 1 determines whether target components are from multi-vendors, that is, the target components are supplied from a plurality of vendors (S2503). When it is determined that the components are from the multi-vendors as a result (YES in S2503), the preventive maintenance support system 1 determines whether the operation of S2501 to S2502 is performed in all the vendors in S2504. When it is determined that the checking operation is performed in all the vendors (YES in S2504), the operation proceeds to S2505. When it is determined that there is the vendor in which the checking operation has not yet been performed (NO in S2504), the operation returns to S2501 and the operation of S2501 to S2502 is performed in the other vendors. Conversely, when it is determined that the components are supplied from the simplex vendor rather than the multi-vendors in S2503 (NO in S2503), the operation proceeds to S2505. In S2505, the preventive maintenance support system 1 lists the acquired maintenance inventory of the components.

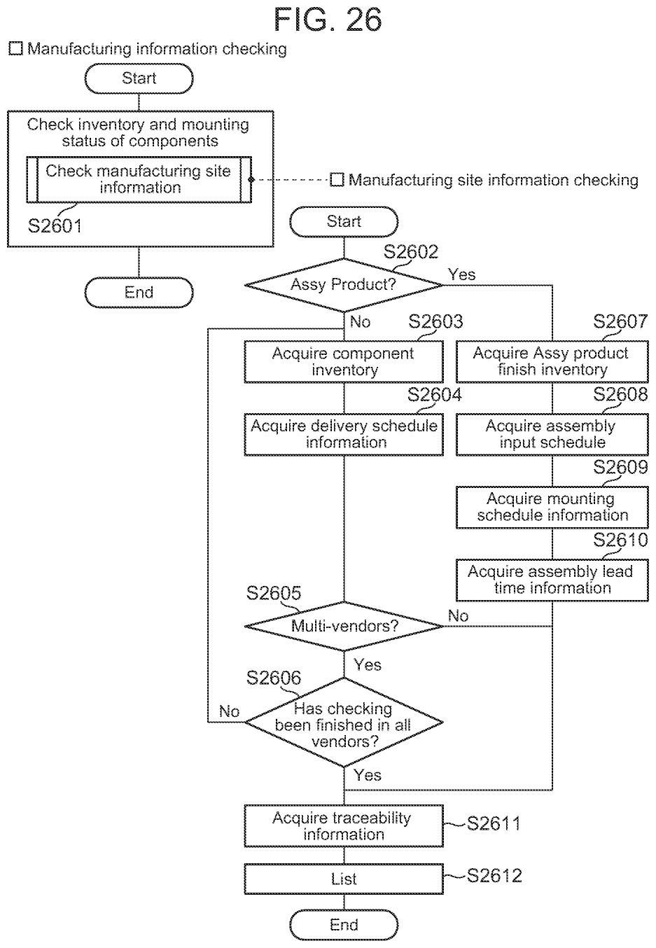

FIG. 26 is a flowchart illustrating an example of a manufacturing information checking operation in the preventive maintenance support system 1 according to the embodiment.

The flowchart illustrated in FIG. 26 is a flowchart for describing an operation in which the preventive maintenance support system 1 checks various kinds of information regarding preventive maintenance target components in the preventive maintenance support system 1 according to the embodiment.

The preventive maintenance support system 1 performs a manufacturing site information checking operation (S2601). In the manufacturing site information checking operation, the preventive maintenance support system 1 first determines whether a checking target component is the Assy product or a simplex component (S2602). When it is determined that the checking target component is the Assy product (YES in S2602), the operation proceeds to S2607. When it is determined that the checking target component is the simplex component (NO in S2602), the operation proceeds to S2603.

In S2603, the preventive maintenance support system 1 acquires component inventory information of the target simplex component. Subsequently, the preventive maintenance support system 1 acquires delivery schedule information of the target simplex component (S2604).

Subsequently, the preventive maintenance support system 1 determines whether target simplex components are from multi-vendors, that is, the target simplex components are supplied from a plurality of vendors (S2605). When it is determined that the components are from the multi-vendors as a result (YES in S2605), the operation proceeds to S2606. When it is determined that the components are supplied from the simplex vendor rather than the multi-vendors (NO in S2605), the operation proceeds to S2611.

In S2606, the preventive maintenance support system 1 determines whether the operation of S2603 to S2604 is performed in all the vendors. When it is determined that the checking operation is performed in all the vendors (YES in S2606), the operation proceeds to S2611. When it is determined that there is the vendor in which the checking operation has not yet been performed (NO in S2606), the operation returns to S2603 and the operation of S2603 to S2604 is performed in the other vendors.

Conversely, in S2607, the preventive maintenance support system 1 acquires finish inventory information of the target Assy product. Subsequently, the preventive maintenance support system 1 acquires assembly input schedule information of the target Assy product (S2608). Further, the preventive maintenance support system 1 acquires mounting schedule information of the Assy product (S2609). The preventive maintenance support system 1 acquires assembly lead time information of the Assy product (S2610).

In S2611, the preventive maintenance support system 1 acquires traceability information of a target component. Then, the preventive maintenance support system 1 lists the information acquired in the flowchart (S2612).

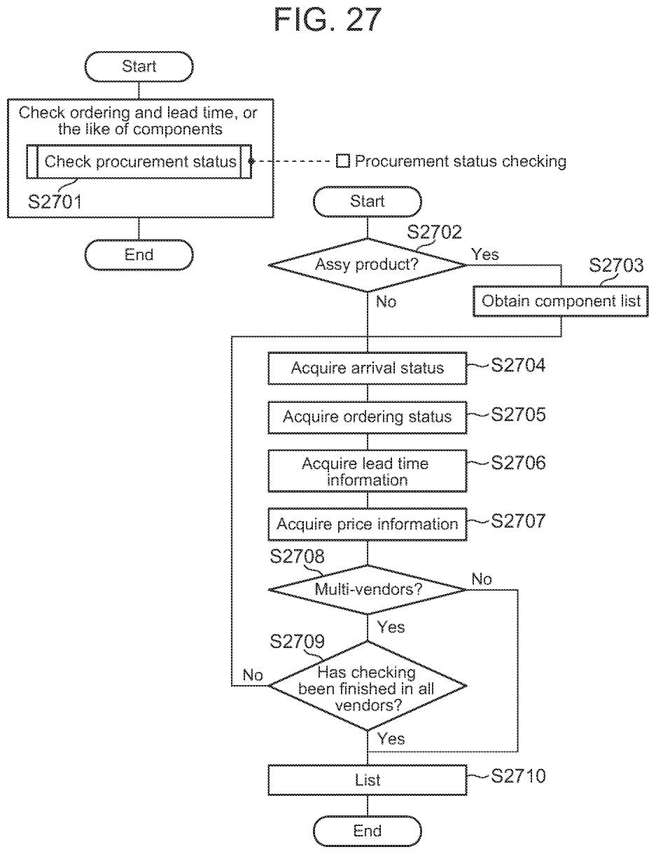

FIG. 27 is a flowchart illustrating an example of a procurement information checking operation in the preventive maintenance support system according to the embodiment.

The flowchart illustrated in FIG. 27 is a flowchart for describing an operation in which the preventive maintenance support system 1 checks a procurement status of preventive maintenance target components in the preventive maintenance support system 1 according to the embodiment.

The preventive maintenance support system 1 performs a procurement information checking operation (S2701). In the procurement information checking operation, the preventive maintenance support system 1 first determines whether the checking target component is the Assy product or the simplex component (S2702). When it is determined that the checking target component is the Assy product (YES in S2702), the operation proceeds to S2703 to acquire a list of the simplex components included in the Assy product. Conversely, when it is determined that the checking target component is the simplex component (NO in S2702), the operation proceeds to S2704.

In S2704, the preventive maintenance support system 1 acquires information regarding an arrival status of the target components. Subsequently, the preventive maintenance support system 1 acquires information regarding an ordering status of the target components (S2705). Further, the preventive maintenance support system 1 acquires information regarding the lead time of the target components (S2706). Then, the preventive maintenance support system 1 acquires price information of the target components (S2707).

Subsequently, the preventive maintenance support system 1 determines whether target components are from multi-vendors, that is, the target components are supplied from a plurality of vendors (S2708). When it is determined that the components are from the multi-vendors as a result (YES in S2708), the operation proceeds to S2709. When it is determined that the components are supplied from the simplex vendor rather than the multi-vendors (NO in S2708), the operation proceeds to S2710.

In S2709, the preventive maintenance support system 1 determines whether the operation of S2704 to S2707 is performed in all the vendors. When it is determined that the checking operation is performed in all the vendors (YES in S2709), the operation proceeds to S2710. When it is determined that there is the vendor in which the checking operation has not yet been performed (NO in S2709), the operation returns to S2704 and the operation of S2704 to S2707 is performed in the other vendors.

In S2710, the preventive maintenance support system 1 lists the information acquired in the flowchart.

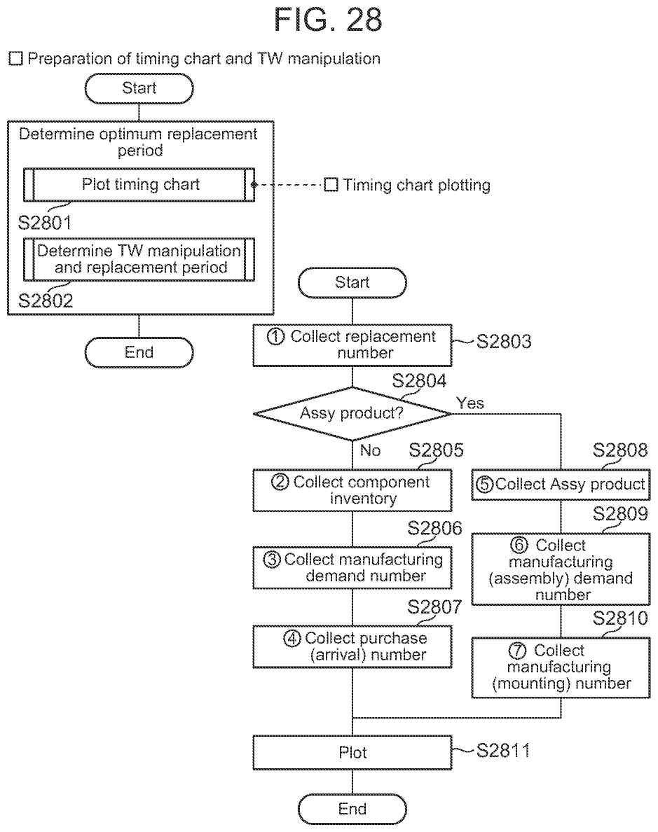

FIG. 28 is a flowchart illustrating an example of an operation of displaying the timing chart in the preventive maintenance support system 1 according to the embodiment.

Flowcharts illustrated in FIGS. 28 to 30 are flowcharts for describing a display operation of the timing chart 300 and the time window 306 and an operation of determining a component replacement timing for preventive maintenance based on the display operation.

First, the preventive maintenance support system 1 performs a timing chart plotting operation (S2801). Subsequently, the preventive maintenance support system 1 performs a time window manipulating operation and a component replacement period determination operation (S2802).

In the timing chart plotting operation, the preventive maintenance support system 1 collects the number of components to be replaced for the preventive maintenance of the target components along the time axis 301 (S2803).

Subsequently, the preventive maintenance support system 1 determines whether the target component is an Assy product or a simplex component (S2804). When the target component is the Assy product (YES in S2804), the operation proceeds to S2808. When the target component is the simplex component (NO in S2804), the operation proceeds to S2805.

In S2805, the preventive maintenance support system 1 collects the component inventory number of the target simplex component. Subsequently, the preventive maintenance support system 1 collects a manufacturing demand number of the target simplex components (S2806). Further, the preventive maintenance support system 1 collects a purchase (arrived) number of target simplex components (S2807).

On the other hand, in S2808, the preventive maintenance support system 1 collects the inventory number of target Assy products. Subsequently, the preventive maintenance support system 1 collects a manufacturing (assembly) demand number of the target Assy product (S2809). Then, the preventive maintenance support system 1 collects a manufacturing (assembly) demand number of products in which the target Assy product is used (S2810).

The preventive maintenance support system 1 generates the timing chart 300 based on the information collected in the flow and causes the display unit 14 to display the generated timing chart 300.

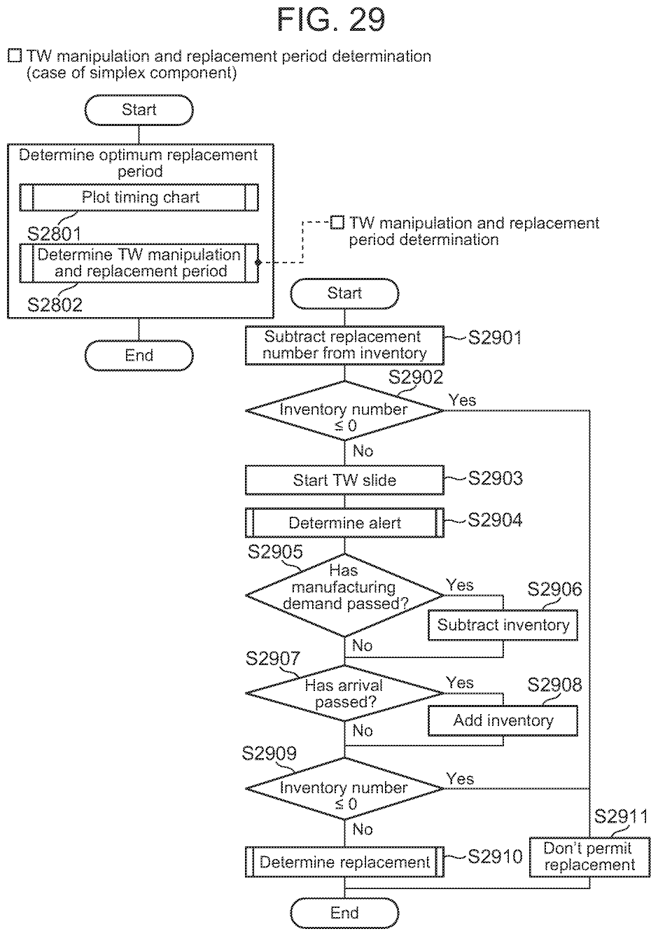

FIG. 29 is a flowchart illustrating an example of an operation of manipulating a time window in the preventive maintenance support system 1 according to the embodiment.

The flowchart illustrated in FIG. 29 is a flowchart for describing an operation of manipulating the time window 306 when a target component is a simplex component.

First, the preventive maintenance support system 1 temporarily subtracts a number (replacement number) of components instructed to be replaced for the preventive maintenance at a present location at which the time window 306 is displayed from the inventory of the target simplex components (S2901). Subsequently, the preventive maintenance support system 1 determines whether the number of components in the inventory subtracted in S2901 is equal to or larger than 0 (S2902). When it is determined that the inventory number is equal to or larger than 0 as a determination result (YES in S2902), the operation proceeds to S2903. When it is determined that the inventory number is smaller than 0 (NO in S2902), the operation proceeds to S2911.

In S2903, the preventive maintenance support system 1 waits for a manipulation input of moving a display position of the time window 306 (sliding along the time axis 301) by the operator using the manipulation unit 15. When there is the manipulation input, the display position of the time window 306 is slid along the time axis 301 based on the manipulation input. Subsequently, the preventive maintenance support system 1 performs an alert determination operation (S2904). The details of the alert determination operation will be described later.

Subsequently, with the sliding of the time window 306, the preventive maintenance support system 1 determines whether the display position of the time window 306 has passed the block 304 related to the product manufacturing timing (S2905). When it is determined that the display position of the time window 306 has passed the block 304 (YES in S2905), the operation proceeds to S2906. When it is determined that the display position of the time window 306 has not yet passed the block 304 (NO in S2905), the operation proceeds to S2907. In S2906, the preventive maintenance support system 1 subtracts the component inventory number.

Subsequently, with the sliding of the time window 306, the preventive maintenance support system 1 determines whether the display position of the time window 306 has passed the block 305 related to the component purchase timing (S2907). When it is determined that the display position of the time window 306 has passed the block 305 (YES in S2907), the operation proceeds to S2908. When it is determined that the display position of the time window 306 has not yet passed the block 305 (NO in S2907), the operation proceeds to S2909. In S2908, the preventive maintenance support system 1 adds the component inventory number.

In S2909, the preventive maintenance support system 1 determines whether the component inventory number of the adds/subtracts result is equal to or larger than 0. When it is determined that the inventory number is equal to or larger than 0 (YES in S2909) as a determination result, the operation proceeds to S2910. When it is determined that the inventory number is smaller than 0 (NO in S2909), the operation proceeds to S2911.

In S2910, the preventive maintenance support system 1 performs a replacement determination operation. The details of the replacement determination operation will be described later.

On the other hand, in S2911, the preventive maintenance support system 1 informs the operator of non-permission of the component replacement through the display unit 14.

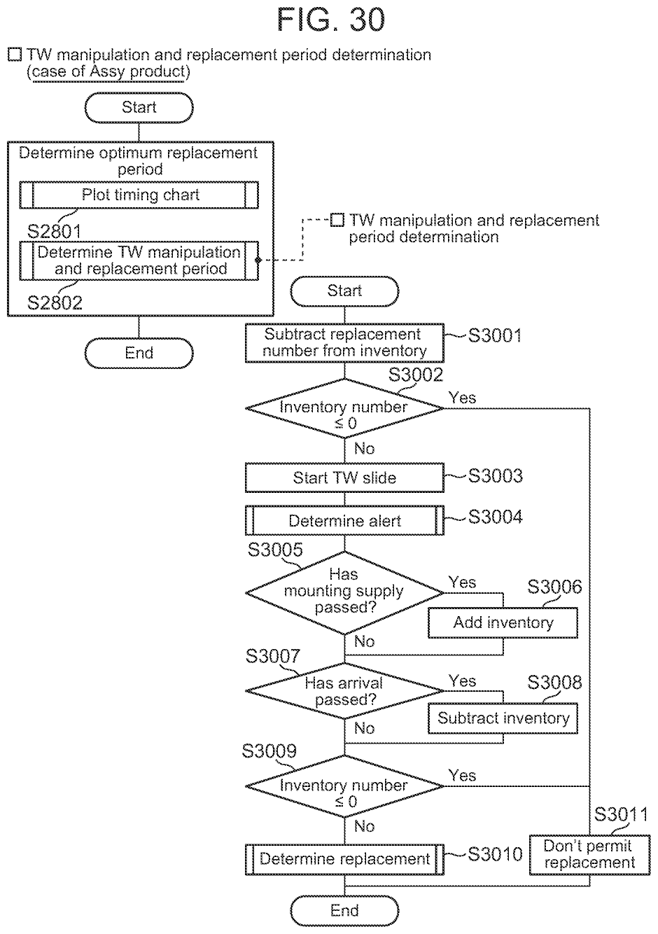

FIG. 30 is a flowchart illustrating another example of the operation of manipulating a time window in the preventive maintenance support system according to the embodiment.

The flowchart illustrated in FIG. 30 is a flowchart for describing an operation of manipulating the time window 306 when a target component is the Assy product. Most of the operation illustrated in the flowchart of FIG. 30 is common to the operation described in the flowchart of FIG. 29. Therefore, only differences will be described.

An operation in steps of S3001 to S3004 are common to the operation in steps of S2901 to S2904 of FIG. 29.

With the sliding of the time window 306, the preventive maintenance support system 1 determines whether the display position of the time window 306 has passed the block related to the mounting supply (that is, assembly of the Assy product) timing (S3005). When it is determined that the display position of the time window 306 has passed the block (YES in S3005), the operation proceeds to S3006. When it is determined that the display position of the time window 306 has not yet passed the block (NO in S3005), the operation proceeds to S3007. In S3006, the preventive maintenance support system 1 adds the component inventory number.

Subsequently, with the sliding of the time window 306, the preventive maintenance support system 1 determines whether the display position of the time window 306 has passed the block related to the manufacturing demand (that is, the product manufacturing) timing (S3007). When it is determined that the display position of the time window 306 has passed the block (YES in S3007), the operation proceeds to S3008. When it is determined that the display position of the time window 306 has not yet passed the block (NO in S3007), the operation proceeds to S3009. In S3008, the preventive maintenance support system 1 subtracts the component inventory number.

An operation in steps of S3010 to S3011 are common to the operation in steps of S2910 to S2911 of FIG. 29.

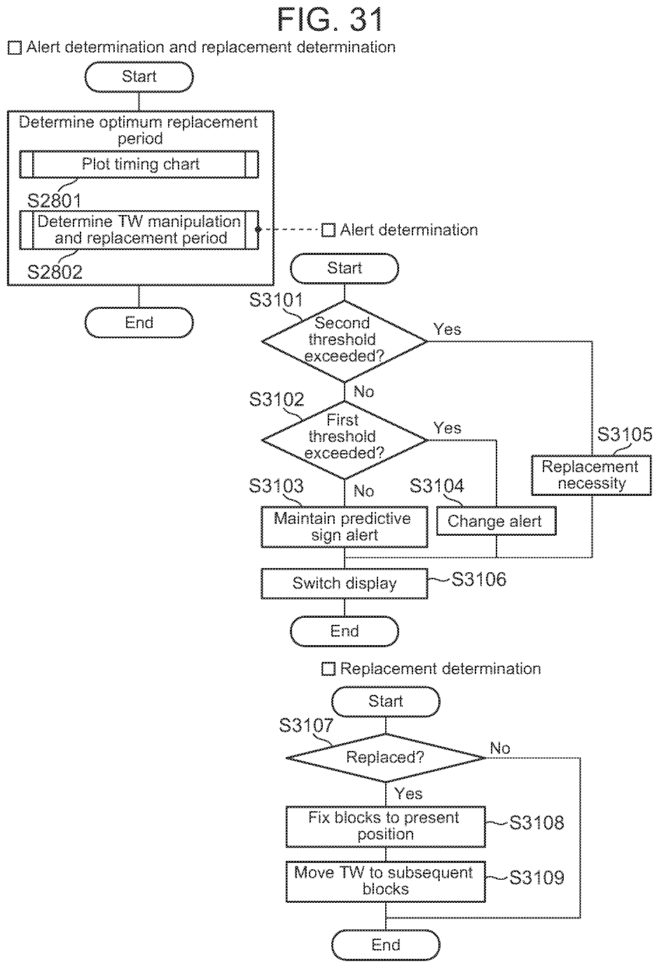

FIG. 31 is a flowchart illustrating an example of an alert determination and replacement determination operation in the preventive maintenance support system 1 according to the embodiment.

The flowchart illustrated in FIG. 31 is a flowchart for describing the details of the alert determination operation of S2904 and S3004 and the replacement determination operation of S2910 and S3010 in the flowcharts of FIGS. 29 and 30.

First, the preventive maintenance support system 1 determines whether a period from a date corresponding to the position of the time window 306 to a date corresponding to the block 303 exceeds a second threshold (S3101). When it is determined that the period exceeds the second threshold (YES in S3101), the operation proceeds to S3105. When it is determined that the period is equal to or smaller than the second threshold (NO in S3101), the operation proceeds to S3102.

Subsequently, the preventive maintenance support system 1 determines whether the period from the date corresponding to the position of the time window 306 to the date corresponding to the block 303 exceeds the first threshold (S3102). When it is determined that the period exceeds the first threshold (YES in S3102), the operation proceeds to S3104. When it is determined that the period is equal to or smaller than the first threshold (NO in S3102), the operation proceeds to S3103.

In S3103, the preventive maintenance support system 1 maintains the display of the block 303 in the predictive sign alert. In S3104, the preventive maintenance support system 1 changes the display of the block 303 to the replacement alert. In S3105, the preventive maintenance support system 1 changes the display of the block 303 to replacement necessity. Then, the preventive maintenance support system 1 switches the display of the block 303 (S3106).

Further, the preventive maintenance support system 1 determines whether there is an instruction to replace the components for the preventive maintenance from the operator performing a manipulation input (S3107). When it is determined that there is the instruction to replace the components (YES in S3107), the operation proceeds to S3108. When it is determined that there is no instruction to replace the components (NO in S3107), the operation ends.

In S3108, the preventive maintenance support system 1 fixes the blocks 303 to 305 displayed in the timing chart 300 to the present position at a present time point. Further, the preventive maintenance support system 1 moves the position of the time window 306 to the subsequent blocks 303 to 305 (S3109).

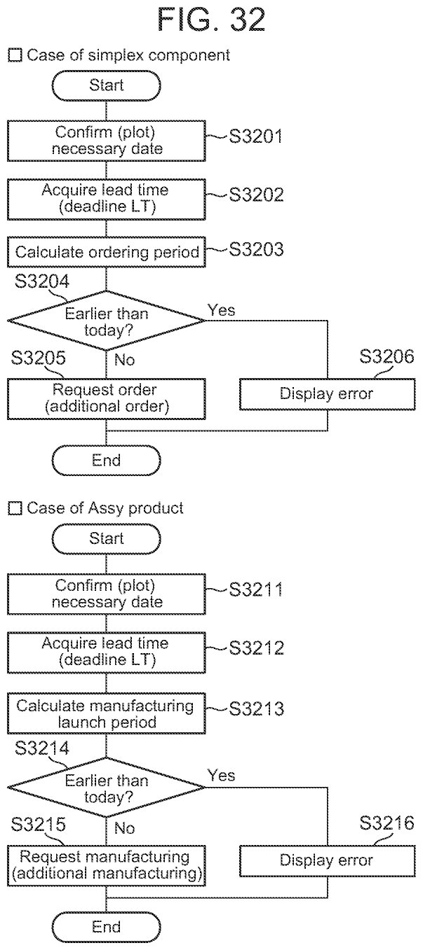

FIG. 32 is a flowchart illustrating an example of an additional component necessity date determination operation in the preventive maintenance support system 1 according to the embodiment.

The flowchart illustrated in FIG. 32 is a flowchart for displaying the block 307 illustrated in FIG. 20 and the block 308 illustrated in FIG. 23, that is, the blocks indicating the timings at which components are delivered when the simplex component or the Assy product is ordered at a designated date.

When the component is a simplex component, the preventive maintenance support system 1 first confirms a necessary date of the component based on a manipulation input of the operator. In other words, based on the manipulation input of the operator, the display position of the block 307 is confirmed (S3201). Subsequently, the preventive maintenance support system 1 acquires the lead time information of the target component (S3202). Then, the preventive maintenance support system 1 calculates an ordering period of the component based on the necessary date of the component and the lead time information (S3203).

Subsequently, the preventive maintenance support system 1 determines whether the ordering period calculated in S3203 is earlier than today (S3204). When it is determined that the ordering period is earlier than today (YES in S3204), the operation proceeds to S3206. When it is determined that the ordering period is later than tomorrow (NO in S3204), the operation proceeds to S3205. In S3205, the preventive maintenance support system 1 request an order. In S3206, an error is displayed on the display unit 14 because the order cannot be made in S3206.

When the component is the Assy product, a flowchart is most common to the flowchart when the component is the simplex component. That is, processing of S3211 to S3212 and S3214 to S3216 is common to processing of S3201 to S3202 and S3204 to S3206. In S3213, the preventive maintenance support system 1 calculates a manufacturing launch period of the Assy product.

As described in detail above, in the preventive maintenance support system 1 according to the embodiment, it is possible to realize the preventive maintenance support system 1 and the preventive maintenance support method capable of sufficiently achieving coordination with a manufacturing schedule.

In the foregoing embodiment, the configurations disclosed to easily describe the present invention have been described in detail. The present invention is not necessarily limited to all the described configurations. Some of the configurations according to the embodiments can be added to, deleted from or substituted with other configurations.

Some or all of the foregoing configurations, functions, processing units, processing mechanisms, and the like may be designed with, for example, integrated circuits to be realized by hardware. The present invention can be realized by program codes of software realizing the functions according to the embodiment. In this case, a storage medium recording the program codes is provided to a computer and a processor included in the computer reads the program codes stored in the storage medium. In this case, the functions according to the above-described embodiments are realized by the program codes read from the storage medium, and the program codes and the storage medium storing the program codes embody the present invention. As the storage medium for supplying the program codes, for example, a flexible disc, a CD-ROM, a DVD-ROM, a hard disk, an SSD (Solid State Drive), an optical disc, a magneto-optical disc, a CD-R, a magnetic tape, a nonvolatile memory card, a ROM, or the like is used.

The program codes realizing the functions described in the embodiment can be mounted in, for example, a widespread program or script language such as Assembly, C/C++, perl, Shell, PHP, Java (registered trademark), or Python.

Some or all of the program codes of software realizing the functions of the embodiments may be stored in advance in the memory unit 11 or may be stored in the memory unit 11 from a non-transitory storage medium of another apparatus connected to a network or from the non-transitory storage medium via the external I/F 17 included in the preventive maintenance support system 1, as necessary.

The program codes of the software realizing the functions of the embodiments may be delivered via a network and the programs may be stored in a storage unit such as a hard disk or a memory of a computer or a storage medium such as a CD-RW or a CD-R, and a processor included in the computer may read and execute the program codes stored in the storage unit or the storage medium.

In the above-described embodiment, control lines or information lines indicate conceivable lines necessary for description and are not necessarily all the control lines or information lines necessary for products. All the configurations may be connected to each other.

What is claimed is:

1. A preventive maintenance support system comprising:
a processor; and
a storage unit,
wherein the processor causes a display apparatus to display a timing chart for displaying a timing at which inventory of components included in a product increases or decreases, a timing at which the components are stocked at a manufacturing site of the product, and a necessary inventory timing at which the components are replaced for preventive maintenance of the product.

2. The preventive maintenance support system according to claim 1, wherein the processor causes the display apparatus to display the timings in a unit in which a time is periodically partitioned.

3. The preventive maintenance support system according to claim 1, wherein the processor causes the display apparatus to display a time window indicating a replacement timing of the components and receives a movement instruction input of the time window to move and cause the display apparatus to display the time window, and further causes the display apparatus to display the timing chart in which the necessary inventory timing is changed based on a display position of the time window.

4. The preventive maintenance support system according to claim 3, wherein the processor causes the display apparatus to display the degree of recommendation for replacing the components in the timing chart based on the display position of the time window.

5. The preventive maintenance support system according to claim 4, wherein the processor causes the display apparatus to change the display of the degree of recommendation for replacing the components based on the movement instruction input of the time window.

6. The preventive maintenance support system according to claim 3, wherein the processor receives a determination input of the component replacement timing based on the display position of the time window.

7. The preventive maintenance support system according to claim 1, wherein the processor causes the display apparatus to display the timing at which the inventory of the components increases or decreases in the timing chart by manufacturing the product based on the components.

8. The preventive maintenance support system according to claim 1, wherein the processor causes the display apparatus to display the timing chart based on data regarding the inventory of the components, data regarding a manufacturing demand number of the product, and data regarding the numbers of the stocked components.

9. The preventive maintenance support system according to claim 1, wherein the processor causes the display apparatus to display the necessary inventory timing in the timing chart based on priority granted to a customer using the product.

10. The preventive maintenance support system according to claim 1, wherein the processor causes the display apparatus to display the timing at which the components ordered for preventive maintenance of the products are stocked in the timing chart.

11. The preventive maintenance support system according to claim 7, wherein the processor causes the display apparatus to display a timing at which manufacturing of the product is finished based on the components in the timing chart.

12. The preventive maintenance support system according to claim 1,
wherein the components include at least one of simplex components included in the product and the components included in assembly components included in the product, and
wherein the processor causes the display apparatus to display the timing chart including a timing at which inventory of the assembly components increases or decreases when the components include the components included in the assembly components.

13. A preventive maintenance support method by a preventive maintenance support system including a processor and a storage unit, the method comprising:
causing a display apparatus to display a timing chart for displaying a timing at which inventory of components included in a product increases or decreases, a timing at which the components are stocked at a manufacturing site of the product, and a necessary inventory timing at which the components are replaced for preventive maintenance of the product.
